(19) United States
(12) Patent Application Publication
(10) Pub. No.: US 2024/0232256 A9
(43) Pub. Date: Jul. 11, 2024

(54) SYSTEM AND METHOD FOR RECOGNIZING MUSIC BASED ON AUDITORY MEMORY AND GENERATING PLAYLISTS

(71) Applicant: Juan Francisco Saavedra Plata, Aventura, FL (US)

(72) Inventor: Juan Francisco Saavedra Plata, Aventura, FL (US)

(21) Appl. No.: 18/491,043

(22) Filed: Oct. 20, 2023

Related U.S. Application Data
(60) Provisional application No. 63/380,277, filed on Oct. 20, 2022.

(51) Int. Cl. G06F 16/638; G06F 3/0482; G06F 3/16; G06F 16/635

(52) U.S. Cl. CPC G06F 16/639; G06F 3/0482; G06F 3/165; G06F 16/637

(57) ABSTRACT

A method for recognizing audio data based on auditory memory includes determining at least one filter to be utilized in the identification of one more audio tracks. The at least one filter includes information related to the one or more audio tracks. The method also includes determining, using one or more machine-learning algorithms, a set of audio clips to be played based on at least one filter. The method includes outputting the set of audio clips in a sequential order. Further, the method includes receiving, from a user, an indication of acceptance of a first audio clip from the set of audio clips. The method includes adding an audio track corresponding to the audio clip to a playlist based on the indication of acceptance.

### CROSS-REFERENCE TO RELATED APPLICATIONS

This application claims the benefit of priority of U.S. provisional application No. 63/380,277, filed Oct. 20, 2022, the entire contents of which are herein incorporated by reference.

### BACKGROUND

The present disclosure relates to music and, more particularly, to a system and method for recognizing music based on auditory memory and generating playlists.

People don't always recall the names of the songs they like, the artists that play them, part of the lyrics, or even the melody. When they try to find those songs or create playlists, they struggle to find a match or even never find the song they were looking for. Additionally, the struggle increases the time required to create a playlist.

Search engines, or playlist composers, require users to be able to recall at least the name of the song, part of the lyrics, the name of the artist, or any specific information so the search engine can provide any relevant feedback. Systems based on a melody or music input require the user either to be able to hum the melody or have the song played.

These systems cannot deliver a solution to users to identify a song. The users find themselves with a song on the back of their head or the tip of their tongue, but can't remember anything, not even the melody. They just know that if they listen to the song, they will recognize it.

As can be seen, there is a need for a system that can identify a song without names, lyrics, melodies, or even the song playing.

### SUMMARY

In one aspect of the present disclosure, a method for recognizing audio data includes determining at least one filter to be utilized in the identification of one more audio tracks. The at least one filter includes information related to the one or more audio tracks. The method also includes determining, using one or more machine-learning algorithms, a set of audio clips to be played based on at least one filter. The method includes outputting the set of audio clips in a sequential order. Further, the method includes receiving, from a user, an indication of acceptance of a first audio clip from the set of audio clips. The method includes adding an audio track corresponding to the audio clip to a playlist based on the indication of acceptance.

In another aspect of the present disclosure, a computer-readable medium stores instructions for causing one or more processors to perform a method. The method includes determining at least one filter to be utilized in the identification of one more audio tracks. The at least one filter includes information related to the one or more audio tracks. The method also includes determining, using one or more machine-learning algorithms, a set of audio clips to be played based on at least one filter. The method includes outputting the set of audio clips in a sequential order. Further, the method includes receiving, from a user, an indication of acceptance of a first audio clip from the set of audio clips. The method includes adding an audio track corresponding to the audio clip to a playlist based on the indication of acceptance.

In another aspect of the present disclosure, a system includes one or more input/output devices, one or more memory devices storing instructions, and one or more processors. The one or more processors are configured to execute the instruction to perform a method. The method for recognizing audio data includes determining at least one filter to be utilized in the identification of one more audio tracks. The at least one filter includes information related to the one or more audio tracks. The method also includes determining, using one or more machine-learning algorithms, a set of audio clips to be played based on at least one filter. The method includes outputting the set of audio clips in a sequential order. Further, the method includes receiving, from a user, an indication of acceptance of a first audio clip from the set of audio clips. The method includes adding an audio track corresponding to the audio clip to a playlist based on the indication of acceptance.

These and other features, aspects and advantages of the present disclosure will become better understood with reference to the following drawings, description, and claims.

### BRIEF DESCRIPTION OF THE DRAWINGS

FIG. 1 is a block diagram of a network environment operating a music application, according to aspects of the present disclosure;

FIG. 2 is a flow diagram of a method for music recognition and playlist creation using the music application of FIG. 1, according to aspects of the present disclosure;

FIG. 3 is an overview diagram of graphical user interfaces generated by the music application of FIG. 1, according to aspects of the present disclosure;

FIG. 4 is a diagram of a filter interface generated by the music application of FIG. 1, according to aspects of the present disclosure;

FIG. 5 is a diagram of a match interface generated by the music application of FIG. 1, according to aspects of the present disclosure;

FIG. 6 is a diagram of a playlist creation interface generated by the music application of FIG. 1, according to aspects of the present disclosure;

FIG. 7 is a diagram of a playlist viewing interface generated by the music application of FIG. 1, according to aspects of the present disclosure; and

FIG. 8 is a diagram of a playlist library interface generated by the music application of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Auditory memory is the only way a person can recognize a song that has listened to before but can't remember any information like the song name, artist, or melody. Only by listening to a fragment of a certain song, a user may unlock those memories. Additionally, when a user just wants to create a playlist with his favorites songs, on traditional music services, the user must look for specific songs and add them one by one in order to build a playlist.

Broadly, aspects of the present disclosure provide systems, methods, and computer-readable media that provide a process to recognize, find songs, and create music playlists using auditory memory. A music application assists users to have a better chance to find the song they are looking for by using their auditory memory. The music application assists users in recognizing a song or even remembering an old one by unlocking memories when they listen to different song clips. The present invention enables users to find a song or create playlists by using their auditory memory when they cannot recall song names, artists, lyrics, melodies, or have the song playing.

In embodiments, a music application can receive some generic data about the songs that a user is attempting to recognize, such as the musical genre, or sub-genre, language, country, the decade to which it belongs, and the like. In response, the music application can instantly play song fragments that match those criteria and allow users to recognize and find them using their auditory memory. At the same time, the present invention enables the user to create playlists without the need to search and add one by one every song.

This music application asks only basic information to a user, such as the genre or language, the year or decade which the song belongs and using a proprietary algorithm, starts playing fragments of songs that the user can like or dislike, and based on that input adjusts every new suggestion that allows the user to find a song, but also to remember previous ones and create playlists with those songs that later can be listened, exported or just copied. this software is the opposite as the user just listen suggested songs fragments based on some criteria he provided and then choose the ones he likes in order to create his playlist, making this entire process much friendly and easier because doesn't have to recall all song names or artists.

The present invention may utilize software based on auditory memory, users does not require specific or detailed information of the song they are looking for, not even the lyrics or the melody, or have any audio source playing the song, they only need to recognize it when a short song preview is automatically played by the application when some basic generic information about the song is provided by the user, like genre or decade among others he can recall.

The present invention improves other systems by significantly increasing the chances of a user to find a song when the user can't recall anything about it, not even hum a melody. It also provides a much easier and faster way to create a playlist instead of looking for every song and adding one by one to a playlist.

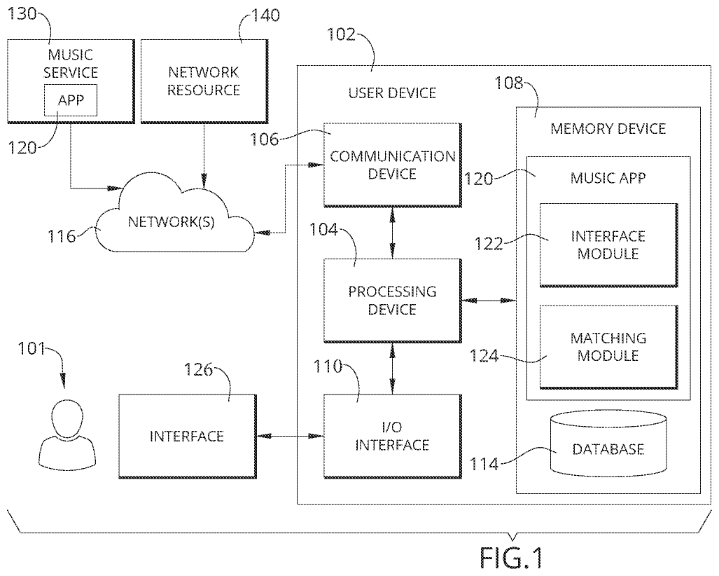

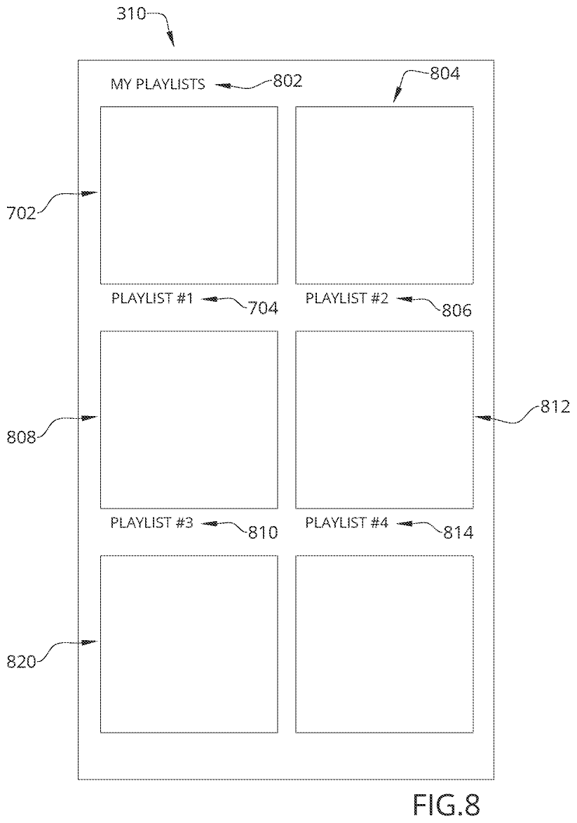

Referring now to FIG. 1-8, FIG. 1 illustrates a network environment 100, according to aspects of the present disclosure. The network environment 100 includes a user device 102 that executes a music application 102. The music application 102 provides graphical user interfaces for guiding a user in identifying music and creating playlists.

The user device 120 can include one or more electronic devices such as a laptop computer, a desktop computer, a tablet computer, a smartphone, a thin client, a smart appliance, and the like. As illustrated in FIG. 1, the user device 102 includes a processing device 104 coupled to a communication device 106. The processing device 104 is also coupled to a memory device 108, and an input/output (“I/O”) interface 110. In embodiments, the communication interface 104 enables the user device 102 to communicate with other devices and systems via one or more networks 116. For example, the user device 102 can communicate with a music service 130 and one or more network resources 140. For example, the one or more network resources 140 can include external databases, social media platforms, search engines, file servers, web servers, or any type of computerized resource that can communicate with the user device 102 via the network 116.

According to the aspects of the present disclosure, the user device 102 stores and executes a music application 120. The music application enables a user 101 of the user device 102 to identify a song or create playlists by using their auditory memory when they cannot recall song names, artists, lyrics, melodies, or have the song playing. The music application 120 can be stored in the memory device 108. The music application 120 can include the necessary logic, instructions, and/or programming to perform the processes and methods described herein. The music application 120 can be written in any programming language.

In embodiments, the music application 120 can be stored and executed on a computer system remote from the user device 102, for example, a music service 130. The user device 102 can access the application remotely via the network 116. For example, the user device 102 can utilize a third-party application, such as a web browser, to access the music application 120 to perform the processes and methods described herein. In embodiments, portions of the music application 120 can be stored and executed on both the user device 102 and a remote computing system and communicate via the network 116. In embodiments, the music application 120 and/or one or more components of the music application 120 can be accessed via one or more application programming interfaces (APIs)

To perform the process described herein, the music application 120 can store and execute an interface module 122 and a matching module 124 to perform the processes and methods described herein. The interface module 140 is configured to generate graphical user interfaces (GUIs), for example, an interface 126 for the music application 120. The interface 126 can include input and output elements, for example, menus, widgets, text, images, fields, etc. The GUIs generated by the interface module 122 can be interactive. For example, the GUI can allow the user 101 of the user devices 102 to perform the processes and method described herein.

The matching module 124 is configured to identify songs using the auditory memory of the user 101. The matching module 124 utilizes filters that operate to select one or more music fragments and/or tracks using artificial intelligence (AI) and/or other machine learning algorithms. The filters define music criteria options that a user may select in order to start the process. The music filters can also be selected automatically by the music application 120. The music filters can include any time of information that can be associated with audio data and music files. For example, the filters can include, but is not limited to, country/region of origin, language, genre (Pop, Rock, Jazz, etc.), time period (specific decades, years, or even eras), vocal type (male, female, instrumental), mood (upbeat, melancholic, energetic, etc.), instruments prominent in the track (guitar, piano, drums, etc.), popularity (chart-toppers, indie gems, etc.), cultural events or trends (songs popular during global events or specific festivals, songs from television shows, etc.), collaborations (duets, band performances, orchestra, etc.) and the like.

For example, the machine-learning algorithm feeds from a tagged dataset of songs with metadata such as genres, time periods, languages, and other defining attributes. Any piece of this metadata can be used as a starting point for our recommendation/matching model, which will shortlist songs aligning with the provided metadata and will begin extracting relationships to other tracks by cross-referencing the shortlisted songs with music consumption data gathered by our platform. Once the user starts to interact with our application, suggestions are adjusted in real-time based on user feedback.

Once the filters are selected, the filters can be applied to AI algorithms in order to select one or more music tracks or clips from a song catalog. The one or more clips are then output to the user 101 for listening. The music application 120 can then receive input provided by the user indicating whether a music fragment is liked or disliked. In response to the user liking a music fragment, the music application 120 can create a playlist with music that was liked. As such, the user 101 can experience the entire music track by using the created playlist. The music application 120 can also allow the user 101 to manage the playlist, for example, name and rename a playlist, add images or other graphics to denote a playlist, rearrange the order of the songs contained in a playlist, remove and/or add music to a playlist, export the playlist to another music service, e.g., music service 130, copy the list of music in the playlists, share a playlist with other users, copy the name, artist, etc. of a music track, and the like. The music application 120 can allow the user 101 to manage the playlist at any time during the process, for example, after one song is added to the playlist.

Additionally, the matching module 124 can use the feedback received from the user 101 to train and refine the AI algorithms for future matching processes and playlist creation. For example, the matching module 124 receives feedback from the user 101, the AI algorithms of matching module 124 can refine future suggestions based on relations, thereby allowing the user 101 can find the music that is the subject of the search and/or use it to create a playlist.

The music application 120 is configured allow the user 101 to end the playlist creation process at any time. The music application 120 can also request that the music application 120 autocomplete the playlist using, for example, the filters and/or criteria entered, the music already added to the playlist, past feedback from the user 101, and the like until a previously set number of music tracks is reached.

The music application 120 is configured to utilize additional data and/or information in the matching process. For example, the music application can utilize prior searches, a user profile, listening habits of the user 101, and the like to perform the matching process. This information can be maintained by the music application 102 and/or received from a third party, e.g., the music service 130, the network resources, etc.

The music application 120 can be configured to operate and/or communicate with a chatbot, virtual/voice assistant, and the like. The chatbot and/or virtual/voice assistant that could ask the user for the input, for example, the filters. The music application 120 can the perform the matching and playlist processes based on the audio input to the chatbot and/or virtual/voice assistant.

The memory device 108 can also include a database 114 that stores information and data associated with the process and methods described herein. The database 114 can store data and content associated with the processes performed by the music application 120. For example, the database 114 can store music and/or music clips that can be accessed and played by the music application 120. The database 114 can also store the filters that can be accessed and played by the music application 120. The database 114 can also store playlist generated by the music application 120. While the database 114 is illustrated as being stored in the user device 102, the database 114 or portion of the database 114 can be stored on a remote computer system, for example, the music service 130.

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the user device 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the *** system 102 can include multiple memory devices 108, whether the same type or different types.

The communication device 104 enables the user device 102 to communicate with other devices and systems. The communication device 104 can include, for example, a networking chip, one or more antennas, and/or one or more communication ports. The communication device 104 can generate radio frequency (RF) signals and transmit the RF signals via one or more of the antennas. The communication device can receive and/or translate the RF signals. The communication device can transceive the RF signals. The RF signals can be broadcast and/or received by the antennas.

The communication device 104 can generate electronic signals and transmit the RF signals via one or more of the communication ports. The communication device 104 can receive the RF signals from one or more of the communication ports. The electronic signals can be transmitted to and/or from a communication hardline by the communication ports. The communication device 104 can generate optical signals and transmit the optical signals to one or more of the communication ports. The communication device 104 can receive the optical signals and/or can generate one or more digital signals based on the optical signals. The optical signals can be transmitted to and/or received from a communication hardline by the communication port, and/or the optical signals can be transmitted and/or received across open space by the networking device.

The communication device 104 can include hardware and/or software for generating and communicating signals over a direct and/or indirect network communication link. For example, the communication device 104 can include a universal serial bus (“USB”) port and a USB wire, and/or an RF antenna with Bluetooth™ programming installed on a processor, such as the processing component, coupled to the antenna. In another example, the communication component can include an RF antenna and programming installed on a processor, such as the processing device, for communicating over a wireless fidelity (“WiFi”) WiFi and/or cellular network. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

In embodiments, the components and functionality of the music application 120 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

The user system 102 can communicate with I/O devices via the I/O interface 112. The I/O devices can display graphical user interfaces (“GUIs”) generated by the music application 120. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

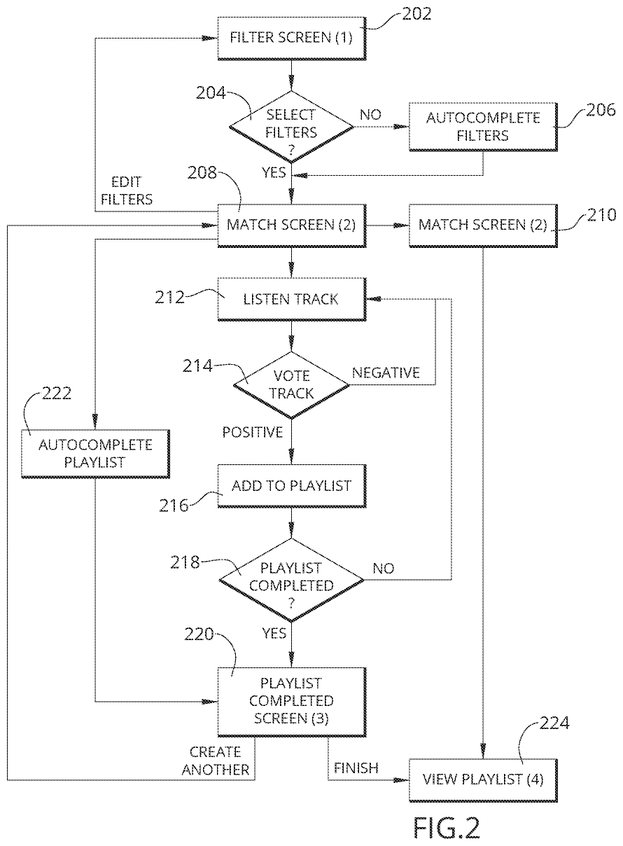

FIG. 2 illustrates a method 200 for identifying music and generating playlists, according to aspects of the present disclosure. The method 200 enables users to find a song or create playlists by using their auditory memory when they cannot recall song names, artists, lyrics, melodies, etc., or play the song. While FIG. 2 illustrates various stages of the method 200, additional stages can be added, and existing stages can be reordered and/or removed.

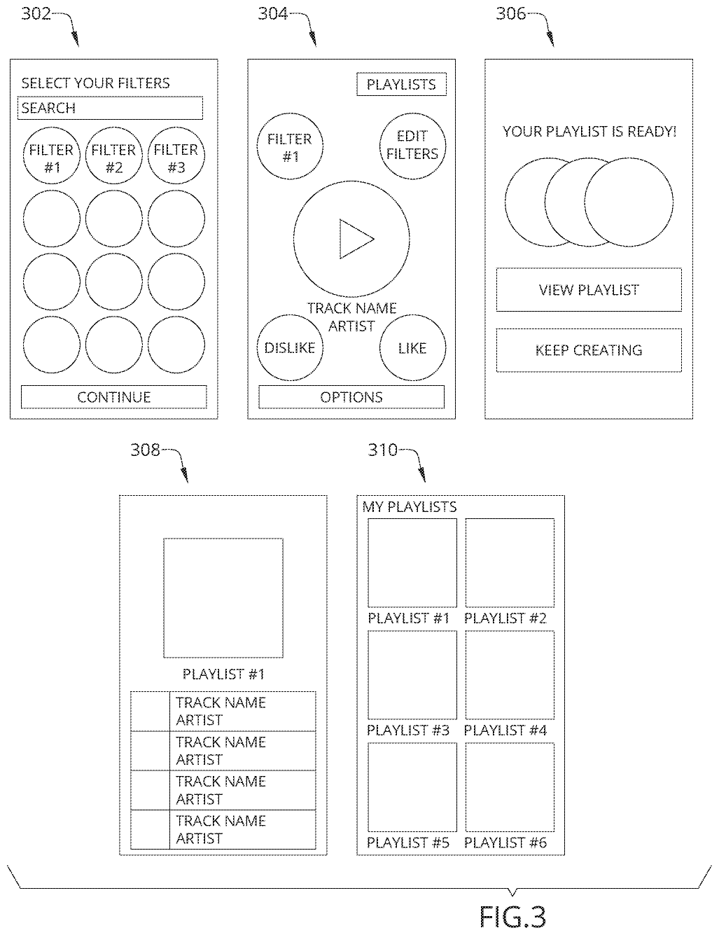

After the music application 120 is initiated and/or accessed, the music application 120 can generate and output one or more GUIs for performing the method 400. FIG. 3 illustrates five (5) examples of GUIs that can be generated and output by the music application 120. The GUIs can include a filter screen 302, a match screen 304, a playlist completed screen 306, a view playlist screen 308, and playlist library screen 310.

In stage 202 a filter screen is displayed. In embodiment, the music application 120 can generate and output one or more GUI that allows the user 101 to locate, view, and select filters. The filters can include any criteria or information that is related to a music track. For example, the filters can include, but is not limited to, country/region of origin, language, genre (Pop, Rock, Jazz, etc.), time period (specific decades, years, or even eras), vocal type (male, female, instrumental), mood (upbeat, melancholic, energetic, etc.), instruments prominent in the track (guitar, piano, drums, etc.), popularity (chart-toppers, indie gems, etc.), cultural events or trends (songs popular during global events or specific festivals, songs from television shows, etc.), collaborations (duets, band performances, orchestra, etc.) and the like..

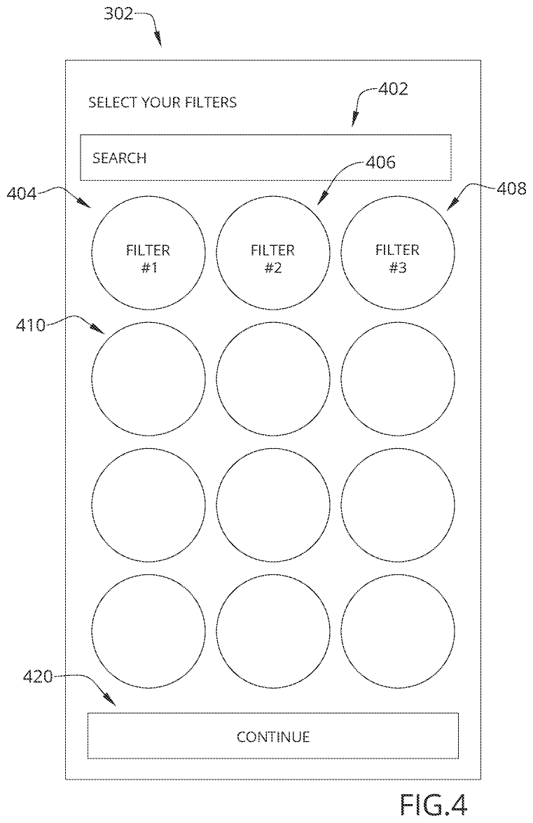

For example, as illustrated in FIG. 4, which shows an example of the filter screen 302, the filter screen 302 includes a search bar 402, filter widgets 404, 406, 408 and 410, and a continue bar 420.

In stage 204, one or more filters can be selected. In embodiments, the music application 120 can receive one or more selections of filters via the GUIs. For example, the search bar 402 can allow the user to enter one or more search terms. The search terms can be used to create new filters. The filter widgets 404, 406, 408 and 410 can display previously used filters and/or preset filters of the music application 120. The user 101 can select one or more filters by selecting one or more of the filter widgets 404, 406, 408 and 410.

If a filter is not selected, in stage 206, the filters can be automatically completed. In embodiments, the music application 120 can use one or more criteria for automatically completing the filters. For example, the music application 120 can utilize user preferences. Over time, the music application 120 learns from user interactions. If a user frequently listens to jazz music from the 50s, music application 120 will lean towards suggesting songs or playlists from that era and genre. Similarly, if Spanish tracks or artists are consistently chosen, the system will prioritize such selections during subsequent interactions. The music application 120 can also utilize previously Created Playlists. The songs and their characteristics in previously created playlists can serve as key data points. For example, if there's a playlist dominated by rock ballads from the 80s, the system can use that information to suggest similar tracks or introduce new rock genres that might be appreciated. The music application 120 can utilize listening history. The songs a user listens to or skips can also taken into account. For instance, if tracks with heavy electronic elements are often skipped, those types of songs might be deprioritized in future recommendations. The music application 120 can utilize user ratings and feedback: music application 120 can obtain song ratings or feedback. A highly-rated song will influence the filters towards suggesting tracks with similar characteristics. The music application 120 can utilize external factors. Considerations like the time of day, season, or even global events can also influence the filters. For example, during festive seasons, the system might lean towards holiday-themed songs. The music application 120 can utilize current music trends. The music application 120 can also factor in the most popular music at any given time, like current chart-toppers. This ensures that users are not only rediscovering past favorites but also staying updated with the latest hits and trends.

After the filters are selected or automatically completed, in stage 208, music matches can be generated and displayed in a match screen. Once the filters are selected, the filters can be applied to AI algorithms in order to select one or more music tracks or clips from a song catalog. The one or more clips are then output to the user 101 for listening. The music application 120 can generate and provide a GUI that allow a user to play the music tracks and/or clips, vote on the clips, display the filters used, edit the filters, add the music tracks to a playlist, and other options.

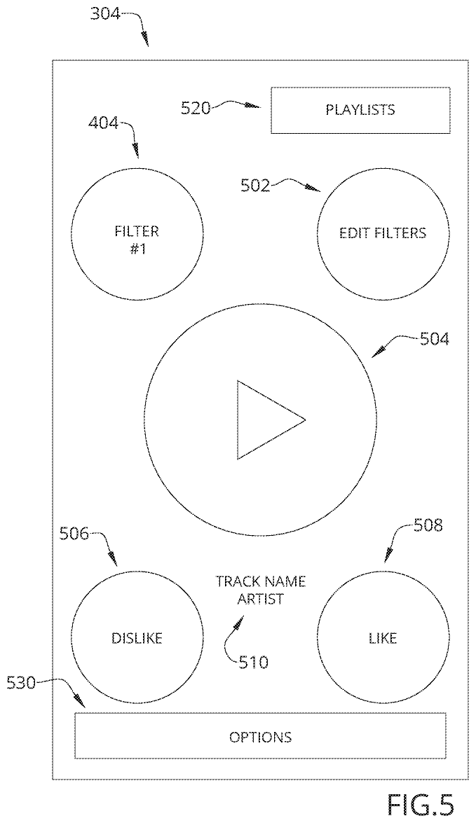

For example, as illustrated in FIG. 5, which shows an example of the match screen 304, the match screen 304 can include a filter widget 404, an edit filters widget 502, a play widget 504, voting widgets 506 and 508, a current track playing display 510, an playlist widget 520, and an option widget 530. The filter widget displays the filter that was used. The user 101 can use the edit filters widget 502 to edits the filters used to identify music tracks.

From the match screen, in stage 212, a music track can be played. The match screen 304 can also include a play widget 504 that allows the user to control the playing of the music tracks and/or clip.

During or after playing the music track, in stage 214, a vote can be received for the music track. For example, the match screen 304 can include voting widgets, for example, a dislike widget 506 and a like widget 508. The user 101 can vote by selecting one of the voting widgets.

If the vote is negative, the method 200 can return to stage 212, a new music track can be played. If the vote is positive, in stage 216, the music track can be added to a playlist.

In stage 218, it can be determined if the playlist is completed. If the playlist is not completed, the method 200 can return to stage 210, and an additional music trap and/or clip can be played. If the playlist is completed, in stage 220, the playlist completed screen can be displayed. For example, the playlist can be completed when the number of matching tracks has been voted on. In another example, the user 101 can indicate that the playlist is completed.

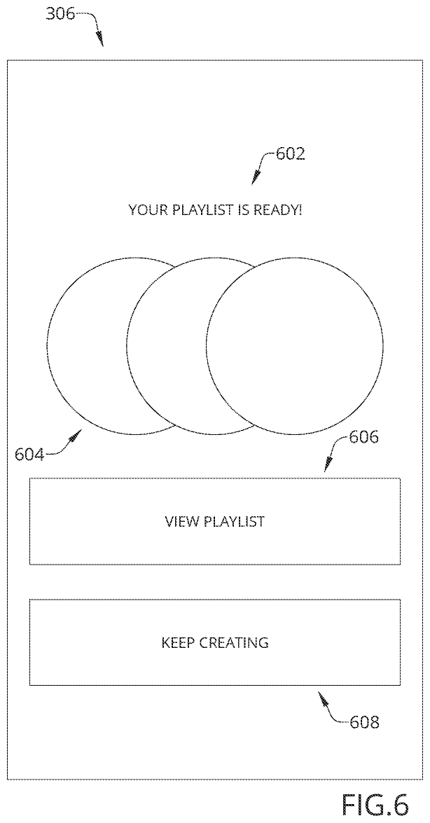

As illustrated in FIG. 6, which shows an example of the playlist completed screen 306, the playlist completed screen 306 can include a banner 602 indicating that the playlist is complete. The playlist completed screen 306 can also include display fields that indicate the tracks that are included in the playlist, for example, listing the title of the music track, the artist for the music track, a graphic of the album, music track artist, etc., and the like.

Optionally, in stage 222, the user 101 can select to automatically create a playlist. In response, the music application 120 can automatically generate a playlist including a predetermined number of music tracks. For example, the music application 120 can also request that the music application 120 autocomplete the playlist using, for example, the filters and/or criteria entered, the music already added to the playlist, past feedback form the user 101, and the like until a previously set number of music tracks is reached.

After the playlist is complete, the user 101 can create another playlist, and the method 200 returns to stage 208. For example, the user can select a keeping creating widget in the playlist completed screen 306.

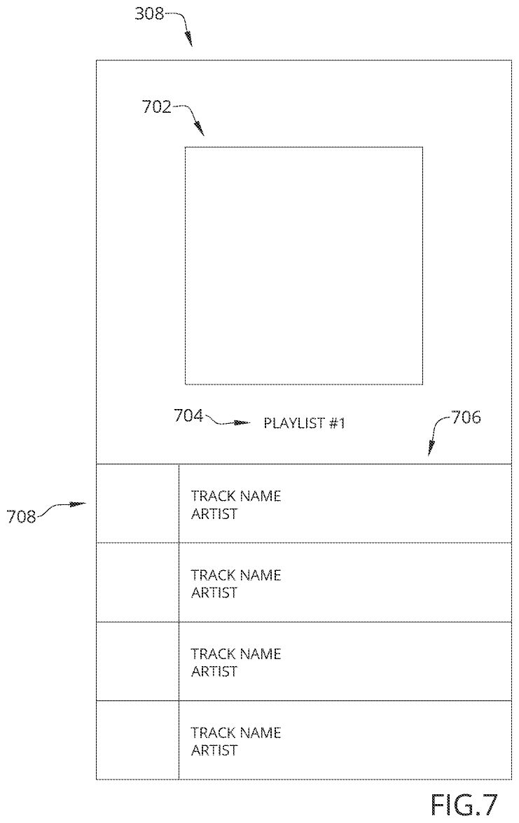

Additionally, after the playlist is complete (or at other times), in stage 224, the user can request to view the playlist. In response, the music application 120 can generate and provide a GUI that displays the contents of the playlist. For example, FIG. 7 shows an example of the view playlist screen 308. The view playlist screen 308 can include identification information such as a graphic 702 and a playlist name 704. The view playlist screen 308 can also include a listing 706 of the music tracks and details 708 of each music track.

Additionally, in stage 210, created playlists can be viewed. In embodiments, the music application 120 can generate a GUI that displays the playlists. For example, FIG. 7 shows an example of the playlist library screen 310. The playlist library screen 310 can include a title graphic 802 and a listing of the playlists for the user 101. For example, the playlist library screen 310 can include the graphic 702 and the playlist name 704 for the Playlist #1. The playlist library screen 310 can include other playlist identification such as a graphic 804 and a playlist name 806, a graphic 808 and a playlist name 810, a graphic 812 and a playlist name 814, and a graphic 820.

In one example, if a user wants to create a playlist with 80s rock hits, on a traditional music streaming service, he must look song by song in order to create a playlist, with this software the user just clicks on a tag named “80s” then on a tag named genre “Rock” and immediately the software will start playing songs fragments so the user can like or dislike in order to create his playlist using his auditory memory. The music application 120 can allow users to apply different music-related filters (e.g. genre, language, etc.). The music application starts playing fragments of songs that match those previously selected filters. Users can like or dislike every fragment played and, with every input received, the music application 120 can adjust the following fragment to play in order to be as accurate as possible based on the user's taste. With every song liked, a new playlist is built, so the user can use the music application 120 not only to find a song but also to create a playlist. Users can then change the order of every song in the playlist, listen to it, copy the songs or export the playlist to another music streaming service. Instead of a song fragment being played, the full song can be reproduced or even just the melody so the user can identify the song.

The music application 120 can be configured to operate and/or communicate with a chatbot, virtual/voice assistant, and the like that could ask the user for the input (filters). then perform the same functionality in order to allow him to find a specific song which he can't remember any information (not even the melody) or to create a playlist by just liking or disliking a song.

As described above, the music application allows users to use their auditory memory to recognize and find a song they do not have any information about or even remember the melody, but at the same time it is a great tool to create playlists in a very unique and innovative way, much faster than any other available system. It can also be used to discover new music. All the information generated by the user input can be used in order to suggest music. The user has several options to choose and select in order to provide the best criteria possible that match to the song he is trying to find or the playlist he wants to create. These options like genre, decade, language, etc., can be the initial data on which the software will pick up the songs to start reproducing fragments of them. The user can edit these at any time these initial criteria. When fragments start playing, users can like or dislike what they listen to. Every time this happens, the software adjusts the next song that will be played to match the user's taste. At the same time, the software will create a playlist with all the songs the user liked. Users can decide how many songs that playlists can have, and they can even instruct the software to auto generate a playlist after at least one like is given. At any time users can listen to their playlist and edit the order of the songs on it.

In some embodiments, the music application 120 can be utilized with the following method steps:
1. User enters the software (App, Web or API).
2. Users select different options such as genre, sub-genre, decade, language, and region/country of the song the user is looking for.
3. The software starts playing fragments of different songs that matches previous criteria selected by the user.
4. The user can like or dislike the song.
5. The software algorithm plays the next song based on the like or dislike provided by the user.
6. The software creates a playlist with all liked songs.
7. User can set the amount of songs to build a playlist.
8. The software can also autocomplete a playlists based on related songs the user already liked.
9. The user can edit and change its initial input selection to keep creating a playlist or to create a new one.
10. All playlists are available for the user to listen and can also edit the order of the songs in the playlist at anytime.
11. The software suggests the user to listen to its playlists in the current streaming service or to export and listen to them in any other music streaming service.

It should be understood, of course, that the foregoing relates to exemplary embodiments of the disclosure and that modifications can be made without departing from the spirit and scope of the disclosure as set forth in the following claims.

What is claimed is:

1. A method for recognizing audio data using auditory memory, the method comprising:
determining at least one filter to be utilized in the identification of one more audio tracks, wherein the at least one filter comprises information related to the one or more audio tracks;
determining, using one or more machine-learning algorithms, a set of audio clips to be played based on at least one filter;
outputting the set of audio clips in a sequential order;
receiving, from a user, an indication of acceptance of a first audio clip from the set of audio clips; and
adding an audio track corresponding to the audio clip to a playlist based on the indication of acceptance.

2. The method of claim 1, the method further comprising:
modifying the one or more machine-learning algorithms based on feedback from the user, wherein the feedback includes one or more of the at least one filter, the indication of acceptance, and information associated with the audio track.

3. The method of claim 1, wherein determining the at least one filter comprises:
receiving, in a graphical user interface, a selection of the at least one filter.

4. The method of claim 3, wherein the graphical user interface displays a listing of predetermined filters.

5. The method of claim 1, wherein determining the at least one filter comprises:
automatically selecting the at least one filter based on prior feedback from a the user.

6. The method of claim 1, the method further comprising:
receiving a request from the user to automatically complete the playlist, wherein the playlist is automatically completed based on prior feedback from the user.

7. The method of claim 1, wherein the filter comprises information associated with one or more properties of music tracks.

8. A computer-readable medium storing instructions that cause one or more processors to perform a method, the method comprising:
determining at least one filter to be utilized in the identification of one more audio tracks, wherein the at least one filter comprises information related to the one or more audio tracks;
determining, using one or more machine-learning algorithms, a set of audio clips to be played based on at least one filter;
outputting the set of audio clips in a sequential order;
receiving, from a user, an indication of acceptance of a first audio clip from the set of audio clips; and
adding an audio track corresponding to the audio clip to a playlist based on the indication of acceptance.

9. The computer-readable medium of claim 8, the method further comprising:
modifying the one or more machine-learning algorithms based on feedback from the user, wherein the feedback includes one or more of the at least one filter, the indication of acceptance, and information associated with the audio track.

10. The computer-readable medium of claim 8, wherein determining the at least one filter comprises:
receiving, in a graphical user interface, a selection of the at least one filter.

11. The computer-readable medium of claim 10, wherein the graphical user interface displays a listing of predetermined filters.

12. The computer-readable medium of claim 8, wherein determining the at least one filter comprises:
automatically selecting the at least one filter based on prior feedback from a the user.

13. The computer-readable medium of claim 8, the method further comprising:
receiving a request from the user to automatically complete the playlist, wherein the playlist is automatically completed based on prior feedback from the user.

14. The computer-readable medium of claim 8, wherein the filter comprises information associated with one or more properties of music tracks.

15. A system comprising:
one or more input/output devices;
one or more memory devices storing instructions;
one or more processors configured to execute the instructions to perform a method, the method comprising:
determining at least one filter to be utilized in the identification of one more audio tracks, wherein the at least one filter comprises information related to the one or more audio tracks;
determining, using one or more machine-learning algorithms, a set of audio clips to be played based on at least one filter;
outputting, on the one or more input/output devices, the set of audio clips in a sequential order;
receiving, from a user via the one or more input/output devices, an indication of acceptance of a first audio clip from the set of audio clips; and
adding an audio track corresponding to the audio clip to a playlist based on the indication of acceptance.

16. The system of claim 15, the method further comprising:
modifying the one or more machine-learning algorithms based on feedback from the user, wherein the feedback includes one or more of the at least one filter, the indication of acceptance, and information associated with the audio track.

17. The system of claim 15, wherein determining the at least one filter comprises:
receiving, in a graphical user interface display on the one or more input/output devices, a selection of the at least one filter, wherein the graphical user interface displays a listing of predetermined filters.

18. The system of claim 15, wherein determining the at least one filter comprises:
automatically selecting the at least one filter based on prior feedback from a the user.

19. The system of claim 15, the method further comprising:
receiving a request from the user to automatically complete the playlist, wherein the playlist is automatically completed based on prior feedback from the user.

20. The system of claim 15, wherein the filter comprises information associated with one or more properties of music tracks.
